(19) United States
(12) Patent Application Publication
(10) Pub. No.: US 2014/0037882 A1
(43) Pub. Date: Feb. 6, 2014

(54) PROCESSES AND STRUCTURES EMPLOYING SILANE-CONTAINING POLYOLEFIN FILMS TENACIOUSLY ADHERED TO SUBSTRATES

(71) Applicant: CHEM LINK, INC., Schoolcraft, MI (US)

(72) Inventors: Phillip C. Georgeau, Kalamazoo, MI (US); Jon H. Ballema, Kalamazoo, MI (US); Dennis J. Kelley, Kalamazoo, MI (US); William L. Machemer, Kalamazoo, MI (US); James M. Larke, Kalamazoo, MI (US)

(73) Assignee: CHEM LINK, INC., Schoolcraft, MI (US)

(21) Appl. No.: 13/799,745

(22) Filed: Mar. 13, 2013

Related U.S. Application Data
(60) Provisional application No. 61/677,544, filed on Jul. 31, 2012.

(51) Int. Cl. C09J 7/02; B32B 7/06; B32B 7/12; B32B 5/02; B32B 37/12

(52) U.S. Cl. CPC C09J 7/0257; B32B 5/028; B32B 37/12; B32B 7/12; B32B 7/06
USPC 428/41.8; 428/447; 442/1; 156/329; 427/207.1

(57) ABSTRACT

Improved adhesive between a sheet material having a low free energy surface, such as a polyolefin, polystyrene, or polyethylene terephthalate film, is achieved by treating the film surface with a silane coupling agent that provides hydrolyzable groups on the surface of the film, and employing an adhesive composition comprising a polymer having reactive silyl groups (e.g., silyl-functionalized polyethers, polyurethanes and/or polyesters). Such improved sheet products can be advantageously employed as weather barriers for building construction applications, eliminating the need for, and disadvantages of, mechanical fasteners.

### CROSS-REFERENCE TO RELATED APPLICATION

This application claims the benefit of U.S. Provisional Application No. 61/677,544 entitled “PROCESSES AND STRUCTURES EMPLOYING SILANE-CONTAINING POLYOLEFIN FILMS TENACIOUSLY ADHERED TO SUBSTRATES” filed on Jul. 31, 2012, the entire contents of which are incorporated by reference.

### FIELD OF THE INVENTION

This disclosure relates to sheet material products, processes for making sheet material products, and processes for using sheet material products in construction and/or manufacturing applications.

### BACKGROUND OF THE INVENTION

Polymeric sheet materials are widely used in the building construction industry, both residential and commercial, such as for providing a weather barrier between interior walls and an exterior facade. An example of such material is sold by DuPont under the Tyvek®) trademark. This material is described as a nonwoven, nonperforated sheet made by spinning extremely fine, continuous high density polyethylene (HDPE) fibers that are fused together to form a strong, uniform web. This fiber structure is engineered to create millions of microscopic pores per square foot of material that resist bulk water and air penetration while allowing moisture vapor to pass through. The DuPont Tyvek® product is alleged to be the only commercially available product using this technology that achieves an optimal balance of air resistance, water resistance and moisture vapor permeability. Other water-resistant barriers are said to compromise such features, such as by sacrificing vapor permeability in order to achieve better moisture resistance.

A problem associated with Tyvek® products, and similar products, is that the materials used for making such products exhibit very low surface free energy, and are consequently incapable of being tenaciously adhered to various building substrates using adhesives. As a result, such materials are fastened to building substrates using mechanical fasteners, such as nails or staples that penetrate the sheet material, providing discontinuities in the film that will allow water penetration.

### BRIEF SUMMARY OF THE INVENTION

In accordance with various embodiments, a sheet material having an intrinsically low surface free energy is treated to impart surface functionalities that facilitate tenacious bonding of the sheet material to a substrate surface using an adhesive composition containing a polymer having reactive silyl groups.

In accordance with other embodiments, a composite film is provided in the form of a multiple layer sheet material having a moisture impermeable film layer comprising a material having a low free energy surface that has been treated to facilitate tenacious adherence with an adhesive composition containing a polymer having reactive silyl groups, an adhesive disposed on the treated surface of the sheet material, the adhesive being a moisture curable structural adhesive containing a polymer having reactive silyl groups, and a release liner disposed over the adhesive to protect the adhesive from moisture prior to its application to a substrate.

In accordance with certain embodiments, there is provided a process for attaching a moisture impermeable sheet material having a low free energy surface to a substrate by treating a surface of the sheet material to enhance adhesion, and using an adhesive composition containing a polymer having reactive silyl groups to obtain a tenacious bond which eliminates the need for mechanical fasteners in various applications

### BRIEF DESCRIPTION OF THE DRAWINGS

FIG. 1 is a fragmentary, cross-sectional view of composite sheet material according to one aspect of the present invention;

FIG. 2 is a roof construction that utilizes the composite sheet material of FIG. 1;

FIG. 3 is an alternative composite sheet embodiment;

FIG. 4 is a composite sheet according to another aspect of the present invention;

FIG. 5 is a composite sheet according to another aspect of the present invention.

### DESCRIPTION OF THE PREFERRED EMBODIMENTS

An object of certain embodiments is to convert a sheet material having a low surface free energy that is incapable of being tenaciously bonded to a substrate using an adhesive into a modified or treated sheet material that is capable of being strongly bonded to a substrate surface using a moisture curable adhesive composition containing a polymer having reactive silyl groups.

Examples of sheet materials having low free energy surfaces include substantially all commercially available polyolefin films, including polypropylene and polyethylene films. Other examples of sheet materials having a low free energy surface that is difficult to adhere to a substrate using an adhesive composition include polyethylene terephthalate (PET) and polystyrene. In general, for purposes of this invention, sheet materials exhibiting a low surface free energy are polymeric film materials having an intrinsic surface energy of about 40 dynes per centimeter or less before treatment.

A technique that is used in accordance with certain embodiments to convert a low free energy surface into a surface that is more amenable to tenacious bonding with a moisture curable adhesive composition containing a polymer having reactive silyl groups involves treating the surface of the sheet material with a silane coupling agent. In general, silane coupling agents have the formula R-(CH₂)ₙ—Si—X₃, wherein R is a nonhydrolyzable organic radical that may possess a functionality that imparts a desired characteristic or which is capable of reacting with the sheet material. X is a hydrolyzable group such as an alkoxy, acyloxy, halogen or amine. The number of repeating methylene (—CH²—) units (n) can be generally any positive integer, such as 1, 2, 3, etc. The silane coupling agent is used to treat a surface of the sheet material, such as by contacting a surface to be treated under suitable conditions with a solution containing the silane coupling agent. Examples of suitable and preferred silane coupling agents that may be employed in the practice of this invention include silylsulfonylazide coupling agents. Other examples may include vinylsilanes, methacryloxy-silanes, alkylsilanes and aminosilanes. The silane coupling agent is selected and the treatment conditions are selected to achieve a modified surface in which hydrolyzable groups are tenaciously coupled to the surface of the sheet material. Such coupling can be via physical interaction, such as hydrogen bonding, or via covalent bonding. The coupling interactions and/or chemical bonding can be achieved between a polymer of which the sheet material is comprised, or between fillers or surface modified fillers distributed in a polymeric matrix.

Once the low free energy surface has been treated to provide hydrolyzable groups at the treated surfaces, the treated sheet can be adhered to various substrates, such as plywood, particle board, or the like using a moisture curable adhesive composition containing a polymer having reactive silyl groups. Examples of suitable moisture curable adhesive compositions containing a polymer having reactive silyl groups that may be employed are described in United States Patent Application Publication No. US 2009/0137711 to Philip C. Georgeau. The entire content of this publication is hereby incorporated by reference herein. In general, suitable moisture curable compositions comprise at least one polymer having silicon-containing hydrolyzable terminal groups. Examples include silyl functionalized polyurethanes, polyethanes and/or polyesters, all of which are commercially available. Desirably, such compositions also contain an organometallic catalyst capable of accelerating the hydrolysis and/or condensation reactions that facilitate curing or thermosetting of the composition and covalent bonding with the hydrolyzable functional groups provided on the treated surfaces of the sheet material. The addition of a rosin ester or tactifying agent may be desirable to obtain some initial adhesion between the sheet material and a substrate to which the sheet material is to be adhered while the composition is cured. Plasticizers, reinforcing pigments, fillers and other optional ingredients, such as those disclosed in United States Patent Application Publication No. 2009/013771 A1, may be used or omitted as desired or as needed.

In accordance with certain embodiments of the invention, the adhesive can be applied to either treated surfaces of the sheet material and/or to the substrate to which the sheet material is to be adhered. For example, plywood surfaces can be sprayed with an adhesive composition and the treated surfaces of the sheet material can be subsequently pressed against the adhesive coating on the plywood (or other substrate) such as immediately after spraying and before substantial curing (crosslinking and/or thermosetting) has occurred.

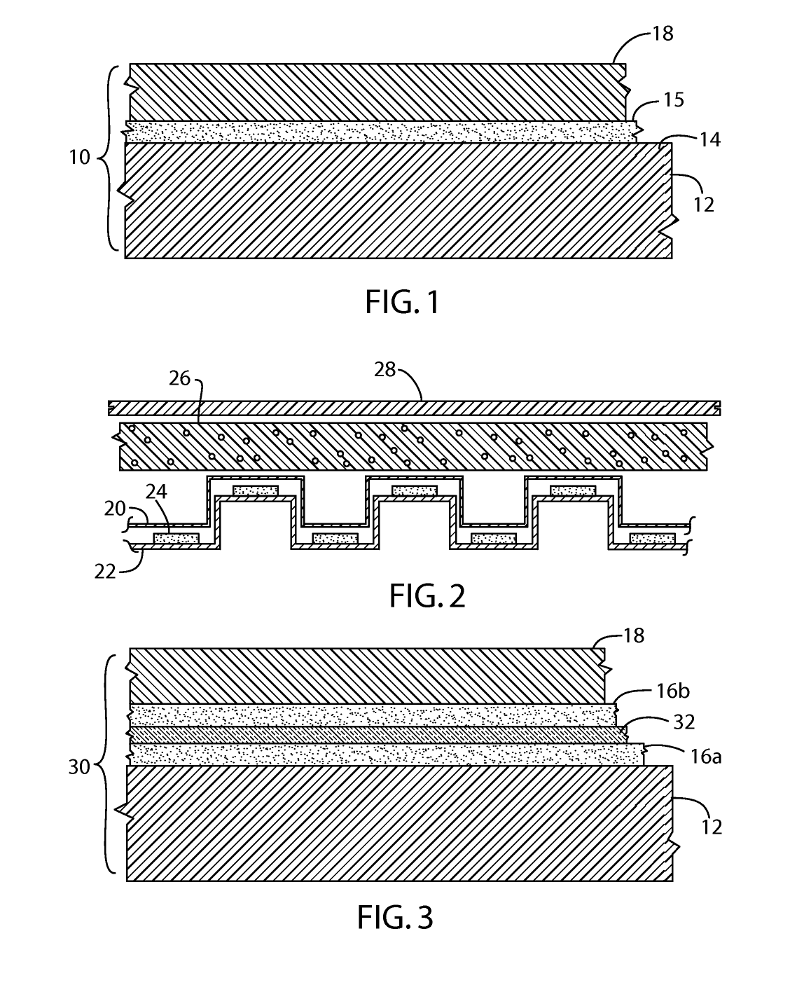

As another alternative, the adhesive can be pre-applied to the treated sheet material and a release liner may be subsequently applied to the adhesive, such that the uncured adhesive is located in the layer between the treated surface of the sheet or film material and the release liner, and is protected against moisture that would initiate curing. In such case, the release liner of the resulting composite sheet material can be removed and the adhesive bearing side of the sheet material can be pressed against a substrate to which it is to be bonded. A composite sheet material 10 is illustrated in the FIG. 1 which shows a sheet or film of material 12 having an intrinsically low surface free energy and a surface 14 which has been subjected to a silane treatment to improve adherability with an adhesive composition comprising a silyl-terminated polymer. A layer of adhesive material 15 is applied to treated surface 14, and release liner 18 is applied over adhesive 15. Examples of suitable release liners include those made of biaxially oriented PET film, biaxially oriented polypropylene, clay coated kraft paper, glassine, etc.

By using the sheet materials and/or composite sheet materials and/or processes of this invention, it is possible to adhere low free energy sheet materials such as polyolefins and PET to various building and/or manufacturing substrates. It is believed that this discovery is somewhat surprising because it is not uncommon to treat materials having a low free energy surface, such as polyolefin films, with a silane coupling agent to prevent adhesion rather than to promote adhesion. It has been discovered that the bonds between the adhesive and the treated sheet material are strong enough that repeated efforts to test the bonds resulted in cohesive failure (i.e., failure within the adhesive), rather than a failure at the interface between the adhesive and the sheet material.

The various embodiments of the invention may be used to seal a building to provide protection from water, water vapor and wind. For example, the sheet materials and/or the composite sheet materials of this invention may be used in place of standard building wrap sheets, thereby eliminating the need for mechanical fasteners, and reducing or eliminating openings for moisture and thereby providing improved barrier efficiency.

In certain embodiments, the film may not be suitable for wall configurations that require moisture vapor escape or a diffusion open design, since the diffusion rate of polymeric film materials is negligible. However, the diffusion rate can be increased with additional processing, such as by employing removable fillers or pore formers that are subsequently removed after the film has been formed, or by using electrostatic bombardment techniques for creating microscopic openings that will allow vapor penetration but prevent water penetration. Also, the techniques of this invention may be used with spun nonwoven fibrous structures, such as the HDPE fiber structure used in the Tyvek® products.

Additionally, the treated surfaces can be subjected to other treatments, either before or after the silane treatment, to further enhance adhesion. Such treatments include corona discharge treatment.

Additionally, the films may be metalized to increase heat reflectance. Desirably, such metallization is on the side of the sheet material opposite the surfaces treated with the silane coupling agent.

A particular application of the invention is illustrated in FIG. 2 which shows a roofing application in which a sheet of material 20 having an intrinsically low surface free energy has been subjected to a silane treatment on its bottom surface to facilitate adhesion to a steel deck 22 via adhesive beads 24. In the illustrated example of FIG. 2, the roof is completed with an insulation board 26 and a roof membrane 28.

An alternative embodiment 30 is shown in FIG. 3. Composite sheet 30 includes a polymer sheet material 12 having an intrinsically low surface free energy as previously described, and an adhesive layer 16a as previously described, which is disposed on one side of sheet 12. In addition, a scrim layer 32 (e.g., a thin layer of woven or non-woven fabric) is bonded to sheet 12 to form a composite membrane. Adhesive layer 16a can partially or completely penetrate pores in scrim 32, partially or completely impregnating scrim 32 with adhesive, optionally providing an outer layer of adhesive 16b on a side of scrim 32 opposite the side contacting adhesive layer 16a disposed between sheet 12 and scrim 32. As with the previously described embodiment of FIG. 1, a release liner 18 can be provided.

A composite membrane may provide additional structural stability and allow for easier use in certain applications. For example, the addition of a scrim would be beneficial when applying the composite directly over a cold applied, hot asphalt or build-up roofing roof (BUR) assembly. The composite membrane allows for better wetting of the underlying roof material, (cold applied adhesive, hot asphalt, or BUR) and better structural stability over time. Additionally, other roofing and air barrier applications may benefit from the structural stability the composite membrane supplies over the sheet alone.

The scrim may be organic or synthetic material and may be woven or non-woven. Organic materials useful as a scrim include but are not limited to: cotton, hemp, bamboo, soy, linen and silk, all of which could be woven or non-woven. Synthetic materials include but are not limited to: non-woven polyester, reclaimed PET, fiberglass and acrylic fibers. The scrim may be bonded to the low energy sheet by utilizing adhesives with the same functionality as Chem Link's or by utilizing inline techniques common to the laminating industry.

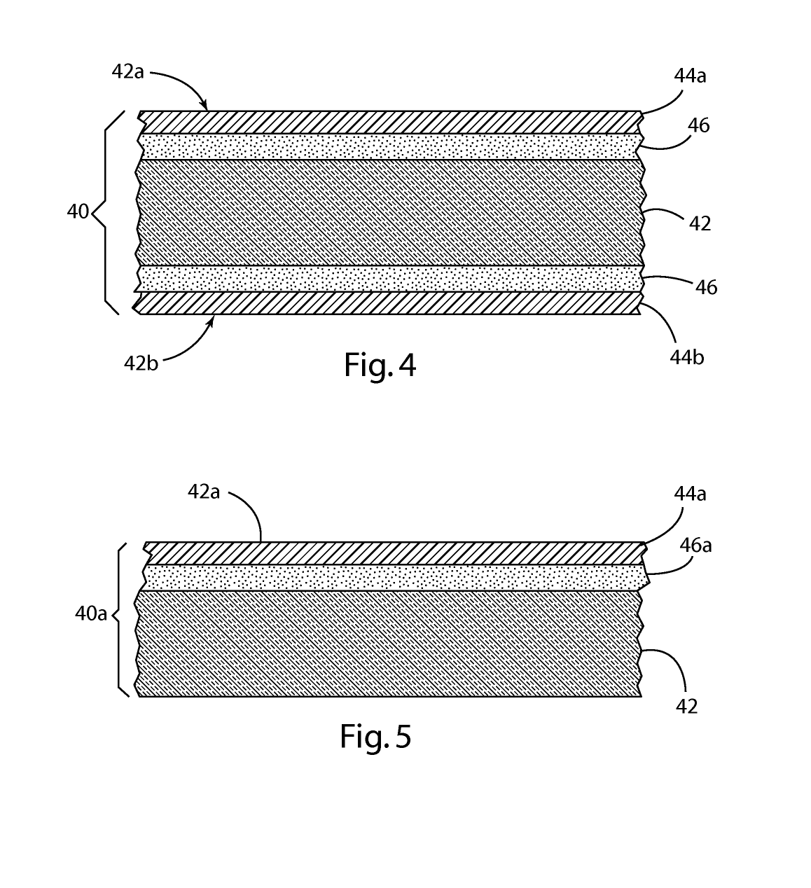

With further reference to FIG. 4, polyolefin films 44a and 44b may be bonded directly to the upper and lower sides of insulation or recovery board 42 during production of the board 42 to form a composite sheet 40. Alternately, a single sheet 44a may be bonded to one side of board 42 as shown in FIG. 5 to form a composite sheet 40a. This can be done utilizing an adhesive process as described above, or it can be accomplished by curing of the board itself while it is in contact with a treated polymer film. For example, a polyester film may be bonded directly to a polyurethane insulation board 42 by incorporating application of the film 44a at the time the insulation board 42 is fabricated. As the polyurethane board 42 is produced, it goes from an uncured reactive state to a cured non-reactive state. Reactive polyurethane has a bonding affinity to polyester. However, a silane treatment would inhibit this bonding affinity. Thus, to fabricate the composite boards 40 and 40a, a polyester film 42a having a non-silane-containing side disposed towards the uncured reactive polyurethane, bonds to the board 42. The polyolefin film in this example would typically have a one-sided silane treatment, with the silane treated side oriented away from the board. The silane treatment provides a bonding site or surface for adhesives and sealants to the polyolefin film as described in more detail above. This process results in an insulation board having an integral moisture barrier (film) on one or both sides, wherein adhesives can be applied directly onto the film to thereby adhere additional components to the board.

A silane-containing polyolefin film can be incorporated onto one or both sides of an insulation board or a recovery/fire prevention board as an integrated moisture barrier. In contrast to existing insulation boards that are permeable to moisture and air, the polyolefin film significantly decreases moisture and air permeability of the insulation layer of a roof or other building structure. Integration of the polyolefin film onto an insulation board reduces the number of steps required for fabricating a roof by eliminating the need for a separate moisture barrier.

Other applications for the invention include metallized heat reflective roofing membranes, roof fixture wrappings, roof membranes, protection from water and salt on highways, bridges and coastal infrastructure construction, and wall aperture wrapping (e.g., at electric outlets, windows and doors). Water and salt protection on highways, bridges and coastal infrastructure construction can be achieved by applying a layer of water proofing (e.g., BARR SG produced by Chem Link), then applying the sheet product of the invention, and finally applying a top coat of the water proofing material. A subsequent course of concrete or asphalt may be deposited on the top coat of water proofing to complete the highway, bridge or infrastructure construction surfaces.

The invention has been described with reference to the preferred embodiments. Of course, modifications and alterations will occur to others upon reading and understanding the preceding description. It is intended that the invention be construed as including all such modifications and alterations insofar as they come within the scope of the appended claims.

What is claimed is:

1. A sheet material comprising;
a layer of material having an intrinsically low surface free energy that has been subjected to a silane treatment on at least one surface to impart improved adherability with an adhesive composition comprising a polymer having reactive silyl groups.

2. The sheet material of claim 1, which has a surface free energy of about 40 dynes per centimeter or less.

3. The sheet material of claim 1, in which the layer of material having an intrinsically low surface free energy is comprised of polystyrene, a polyolefin, or polyethylene terephthalate.

4. The sheet material of claim 1, in which the silane treatment provides a hydrolyzable group bonded to a silicon atom that is coupled to a surface of the layer of material having an intrinsically low surface free energy.

5. The polymeric sheet material of claim 1, in which the hydrolyzable group is an alkoxy, acyloxy, halogen or amine.

6. A composite sheet material comprising;
a sheet of material having an intrinsically low surface free energy that has been subjected to a silane treatment on at least one surface to impart improved adherability with an adhesive composition comprising a polymer have reactive silyl groups;
a layer of an adhesive composition comprising a polymer having reactive silyl groups deposited on the treated surface; and
a release liner positioned against the adhesive layer.

7. A process for preparing a sheet material, comprising;
providing a layer of material having an intrinsically low surface free energy; and
subjecting at least one surface of the layer of material to a silane treatment to impart improved adherability with an adhesive composition comprising a polymer having reactive silyl groups.

8. A process for attaching a sheet material having an intrinsically low surface free energy to a substrate, comprising;
providing a layer of material having an intrinsically low surface free energy that has been subjected to a silane treatment on at least one surface to impart improved adherability with an adhesive composition comprising a polymer having reactive silyl groups;
applying an adhesive composition comprising a polymer having reactive silyl groups to at least one of the treated surface and a substrate to which the sheet material is to be adhered; and
pressing the sheet material against the substrate to which the sheet material is to be adhered with the adhesive located between the sheet material and the substrate.

9. A composite sheet material comprising;
a sheet of material having an intrinsically low surface free energy that has been subjected to a silane treatment on at least one surface to impart improved adherability with an adhesive composition comprising a polymer have reactive silyl groups;
a layer of an adhesive composition comprising a polymer having reactive silyl groups deposited on the treated surface; and
a scrim adhered to the sheet by the adhesive composition.

10. A composite sheet material according to claim 9, in which the scrim is impregnated by the adhesive.

11. A composite sheet material according to claim 10, in which the adhesive is disposed on both sides of the scrim.

12. A composite sheet material according to claim 11, further comprising a release liner positioned over the adhesive impregnated scrim.
